(19) United States
(12) Patent Application Publication
(10) Pub. No.: US 2016/0288613 A1
(43) Pub. Date: Oct. 6, 2016

(54) APPARATUS AND A METHOD FOR PREVENTING SNOW INFILTRATION OF A VEHICLE HVAC SYSTEM

(71) Applicant: FORD GLOBAL TECHNOLOGIES, LLC, Dearborn, MI (US)

(72) Inventor: Robert Steven Sawyer, Oakland, MI (US)

(21) Appl. No.: 14/676,038

(22) Filed: Apr. 1, 2015

(51) Int. Cl. B60H 1/00; B60H 1/26

(52) U.S. Cl. CPC B60H 1/00849; B60H 1/00742; B60H 1/00764; B60H 1/26

(57) ABSTRACT

An apparatus and method are provided for preventing snow infiltration of a vehicle HVAC system. The apparatus includes a fresh air inlet door for drawing fresh air into the vehicle HVAC system, an actuator for opening and closing that fresh air inlet door and a controller connected to the actuator and configured to close the inlet door when the ignition switch of the motor vehicle is switched off.

### TECHNICAL FIELD

This document relates generally to the motor vehicle field and, more particularly, to an apparatus and method for preventing snow infiltration of a vehicle HVAC system.

### BACKGROUND

Snowflakes in many venues around the world including northern North America are usually dry and very small or fine. This type of snowflake is easily blown around, even in light winds, and may infiltrate very small and tight areas. When a motor vehicle is parked in inclement winter weather conditions and the HVAC system is left in fresh air mode with the fresh air inlet open, these fine, dry snowflakes can be blown toward the fresh air inlet and ingested into the HVAC ventilation system. Sometime later when the vehicle operator enters the vehicle, turns on the vehicle ignition and initiates operation of the HVAC system fan, these snowflakes previously ingested into the HVAC system may be blown through the HVAC system vents into the interior of the vehicle and onto the vehicle occupants. This can create dissatisfaction with the motor vehicle.

This document relates to a new and improved apparatus and method for preventing snow infiltration of a vehicle HVAC system and thereby avoiding this problem.

### SUMMARY

In accordance with the purposes and benefits described herein, an apparatus is provided for preventing snow infiltration of a vehicle HVAC system. That apparatus may be broadly described as comprising a fresh air inlet door for drawing fresh air into the vehicle HVAC system, an actuator for opening and closing the fresh air inlet door and a controller. The controller is connected to the actuator and configured to close the inlet door when an ignition switch of the motor vehicle is switched off. Advantageously, the closed fresh air inlet door prevents ingestion of snowflakes into the HVAC ventilation system of the motor vehicle when the vehicle is parked and unoccupied.

In one possible embodiment, the controller includes an ignition status component that monitors the status of the ignition switch. In another possible embodiment, the controller includes an ambient temperature component that monitors ambient temperature. In this embodiment, the controller is configured to close the inlet door only when the ignition switch is switched off and the ambient temperature is below a predetermined trigger temperature.

In yet another possible embodiment, the controller includes a vehicle door status component that monitors the opening and closing of at least one door of the motor vehicle and preferably all doors. In this embodiment, the controller is configured to close the inlet door only when the ignition switch is switched off, the ambient temperature is below a predetermined trigger temperature and the at least one vehicle door has been opened and closed, or at least one vehicle door has been unlocked by a key fob.

In yet another possible embodiment, the controller includes a timer component and a counter component for timing and counting the opening of the at least one vehicle door. Further, the timer and counter components may be used for timing and counting the closing of the fresh air inlet door.

In yet another possible embodiment, the apparatus includes a vehicle occupant monitor for monitoring the occupancy within the vehicle. The controller is responsive to the vehicle occupant monitor and configured to close the inlet door only when the ignition switch is switched off, the ambient temperature is below the predetermined trigger temperature, all vehicle doors are closed and the vehicle is free of any occupant.

In accordance with an additional aspect, a method is provided for preventing snow infiltration of the vehicle HVAC system. That method may be broadly described as comprising the steps of monitoring ignition status by means of an ignition status component of a controller and closing a fresh air inlet door of the HVAC system by means of an actuator under control of the controller when the ignition is switched off.

In one possible embodiment, the method further includes monitoring ambient temperature by means of an ambient temperature status component of the controller. In this embodiment, the fresh air in door is closed only when the ignition is switched off and the temperature is below the predetermined trigger temperature.

In yet another embodiment, the method includes monitoring the vehicle door status by means of a vehicle door status component of the controller. In this embodiment, the fresh air inlet door is only closed when the ignition is switched off, the temperature is below the predetermined trigger temperature and the vehicle doors have been opened to allow exit of vehicle occupants and then closed whereby air pressure is vented from the vehicle through the fresh air inlet as the vehicle doors are closed before closing the fresh air inlet door to prevent snow infiltration.

In yet another possible embodiment, the method includes monitoring vehicle occupancy status by means of a vehicle occupant monitor and closing the fresh air inlet door only when the ignition switch is switched off, the ambient temperature is below the predetermined trigger temperature, all vehicle doors are closed and the vehicle is free of any occupant.

In the following description, there are shown and described several preferred embodiments of the apparatus and method for preventing snow infiltration of the vehicle HVAC system. As it should be realized, the apparatus and method are capable of other, different embodiments and their several details are capable of modification in various, obvious aspects all without departing from the apparatus and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the apparatus and method for preventing snow infiltration of the vehicle HVAC system and together with the description serve to explain certain principles thereof. In the drawing figures:

FIG. 1 is a schematic block diagram of the apparatus.

FIGS. 2a and 2b are flowcharts of the method of operation of the apparatus shown in FIG. 1. More specifically, FIG. 2a relates to the operating procedure when the vehicle ignition is switched off while FIG. 2b illustrates the operating procedure when the vehicle ignition is subsequently switched on, or a door has been unlocked with a key fob.

Reference will now be made in detail to the present preferred embodiments of the apparatus and method, examples of which are illustrated in the accompanying drawing figures.

### DETAILED DESCRIPTION

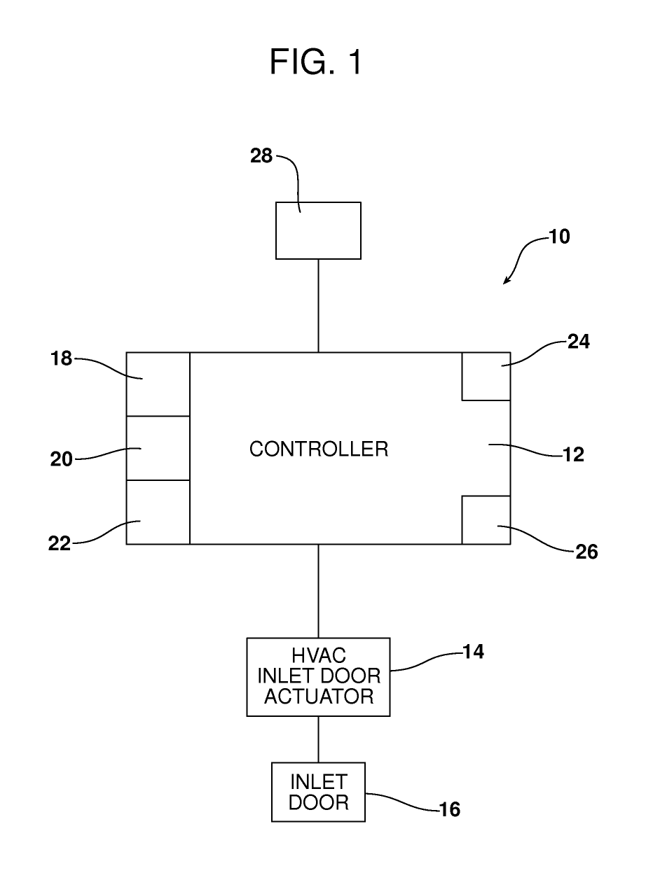

Reference is now made to FIG. 1 illustrating the apparatus 10 for preventing snow infiltration of a vehicle HVAC system. As illustrated in FIG. 1, the apparatus 10 includes a controller 12 that is connected to an HVAC inlet door actuator 14 which is operated to open and close an inlet door 16 that covers and uncovers a fresh air inlet leading to a blower (not shown) of the HVAC ventilation system. The controller 12 may comprise a dedicated microprocessor or an electronic control unit (ECU) running appropriate software. In one possible embodiment, the controller 12 may comprise a body control module or BCM which comprises a computing device having one or more processors, one or more memories, one or more network interfaces, a human interface, a GPS/Geo locator component, a display device such as a multifunction display with touchscreen capability and a speech processor that all communicate with each other over a communication bus. A BCM controller 12 performs a number of interior body electrically based functions including, for example, interior locking, remote key entry, interior light, exterior light, windshield wiper control and the like. In some embodiments, the BCM controller 12 may also function to control entertainment functions (e.g. radio, CD player and communications such as telephone and internet communications over a wireless network). In some embodiments, the BCM controller 12 may be connected by communication bus (not shown) to other control modules that provide one or more of these additional functions.

In the embodiment illustrated in FIG. 1, the controller 12 includes an ignition status or an RPM component 18, an ambient temperature component 20, a vehicle door or door lock status component 22, a timer component 24 and a counter component 26. The operation of the controller 12 and the function of the various components 18, 20, 22, 24, 26 will be made apparent from the following description. In all embodiments of the apparatus 10, the controller 12 is connected to the actuator 14 and configured to close the inlet door 16 when the ignition switch of the motor vehicle is switched off or engine RPMs are at zero.

The ignition status component 18 monitors the status of the vehicle ignition switch. Where the controller 12 includes both an ignition status component 18 and an ambient temperature component 20, the controller 12 is configured to close the inlet door 16 only when the ignition switch is switched off and the ambient temperature is below a predetermined trigger temperature. It is the function of the ambient temperature component 22 to monitor the ambient temperature and when that ambient temperature falls below the trigger temperature (e.g. 0° C.), a condition is met for closing the inlet door 16.

In contrast, where the controller 12 includes an engine RPM component 18, the component monitors engine RPMs. When the controller 12 includes both an engine RPM component 18 and an ambient temperature component 20, the controller 12 is configured to close the inlet door 16 only when the engine RPMs are at zero and the ambient temperature is below the predetermined trigger temperature.

Where the controller 12 includes an ignition status component 18, an ambient temperature component 20 and a vehicle door status component 22, the controller is configured to close the inlet door 16 when the ignition switch is switched off, the ambient temperature is below the predetermined trigger temperature and at least one vehicle door or all the vehicle doors have been opened and closed. It is the function of the vehicle door status component 22 to monitor the opening and closing of the vehicle doors.

The vehicle door status component 22 provides the apparatus 10 with a significant benefit. Specifically, it allows the occupants of the vehicle to open the vehicle doors, exit the vehicle and close the vehicle doors before the controller closes the inlet door 16 to the fresh air inlet of the HVAC system. Thus, that inlet remains open when the doors are closed, providing an avenue for venting the interior of the motor vehicle and preventing a buildup of pressure which would otherwise make it difficult to fully close the vehicle door. Only after all of the doors have been opened and closed and the vehicle is occupant free does the controller 12 function to close the inlet door 16 to prevent infiltration of snow into the vehicle HVAC system.

In an alternative embodiment, a vehicle door lock status component may be substituted for the vehicle door status component 22. The vehicle door lock status component monitors vehicle door lock status noting whenever one or more vehicle doors are locked or unlocked using a key fob. When the vehicle doors are locked with the key fob, the ignition is off and the temperature is below the predetermined trigger temperature, the inlet door 16 is closed.

In accordance with yet another possible embodiment, the apparatus 10 may include an optional occupant monitor 28, to monitor the occupancy of the vehicle and to confirm when the vehicle is free of any occupants. Such an occupant monitor 28 may comprise, for example, a camera, infrared sensors or the like. In this embodiment of the apparatus 10, the controller 12 is configured to only close the inlet door 16 when the ignition is off, the ambient temperature is below the predetermined trigger temperature, all the vehicle doors are closed and the occupancy monitor 28 indicates that the vehicle is free of any occupant.

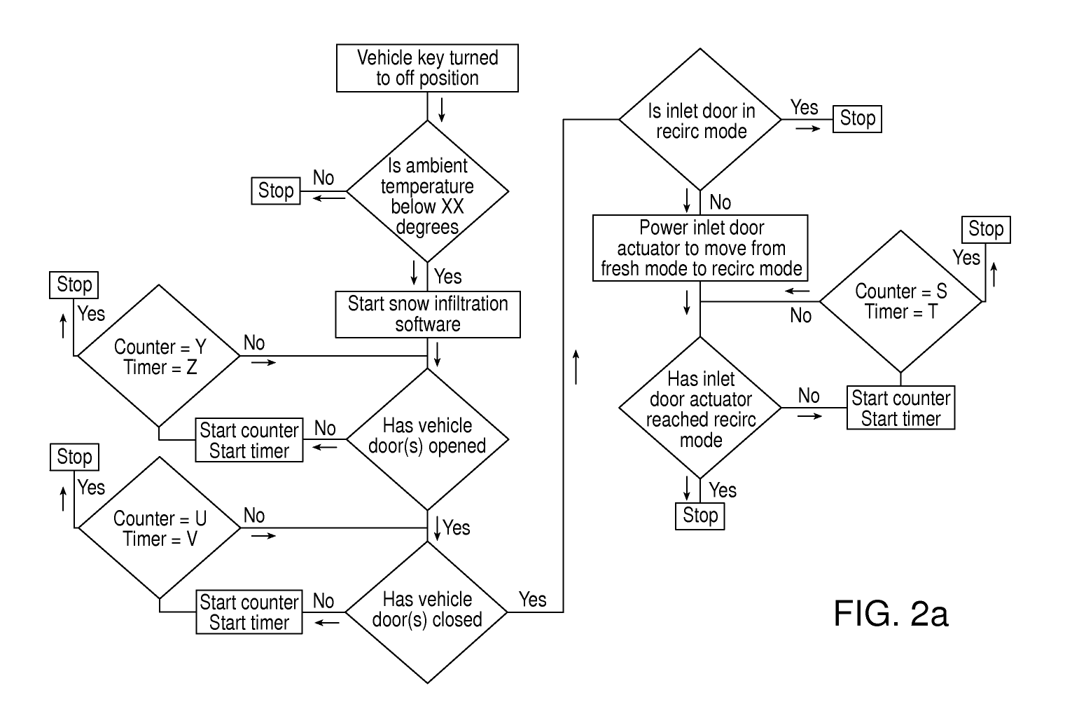

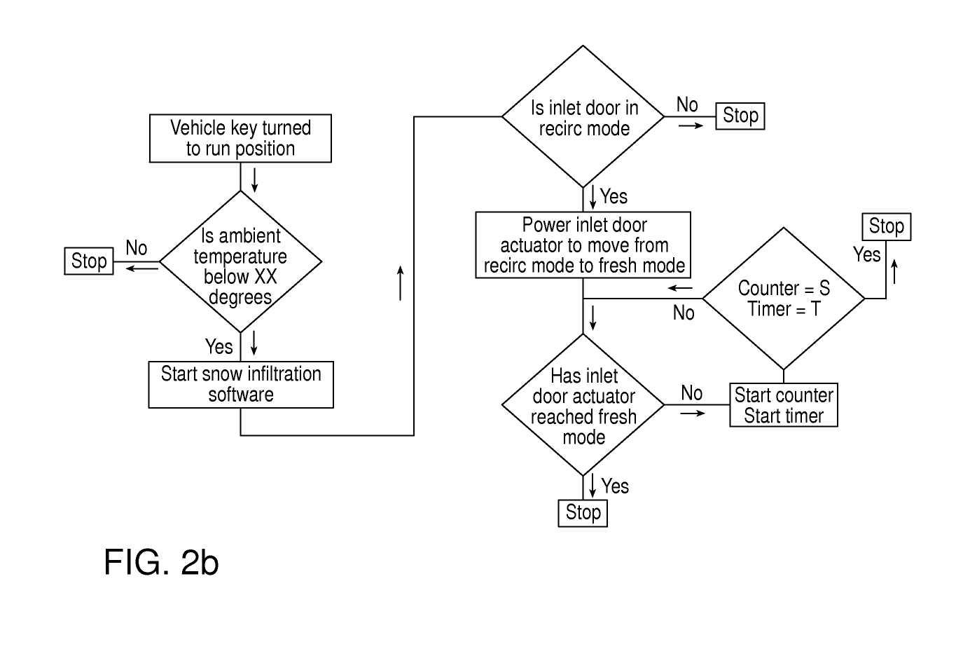

Reference is now made to FIGS. 2a and 2b which are flowcharts that generally summarize the operating method of the apparatus 10. That method may be broadly described as comprising the steps of monitoring the ignition status of the vehicle by means of an ignition status component 18 of the controller 12 and closing a fresh air inlet door 16 of the HVAC system by means of the actuator 14 under control of the controller when the ignition is switched off.

In the embodiment of the apparatus 10 incorporating an ignition status component 18 and an ambient temperature component 20, the method further includes the monitoring of the ambient temperature by means of the ambient temperature status component and closing the fresh air inlet door 16 only when the ignition is switched off and the temperature is below the predetermined trigger temperature.

In an embodiment of the apparatus 10 wherein the controller 12 includes an ignition status component 18, an ambient temperature component 20 and a vehicle door status component 22, the method further includes monitoring the vehicle door status by means of the vehicle door status component. Further the method includes closing the fresh air inlet door 16 only when the ignition is switched off, the temperature is below the predetermined trigger temperature and the vehicle doors have been opened to allow exit of vehicle occupants and then closed whereby air pressure is vented from the vehicle through the fresh air inlet as the vehicle doors are closed before closing the fresh air inlet to prevent snow infiltration.

In the embodiment of the apparatus 10 further including the occupancy monitor 28, the method includes monitoring the vehicle occupancy status of the vehicle with the occupancy monitor and closing the fresh air inlet door 16 only when the ignition switch is switched off, the ambient temperature is below the predetermined trigger temperature, all vehicle doors are closed and the vehicle is free of any occupant.

As illustrated in FIGS. 2a and 2b, the timer component 24 and counter component 26 of the controller 12 serve several different functions. As illustrated, the timer component 24 provides a specific time frame for monitoring whether the vehicle doors have opened for the exit of vehicle occupants and whether the vehicle doors have closed following exit of the vehicle occupants. The counter will restart the timer for a given number of times before ceasing operation of the snow infiltration prevention system. As further illustrated, the timer component 24 and counter component 26 are also active to ensure that the inlet door 16 is (a) shut when the vehicle ignition switch is switched off and other requirements are met or (b) opened when the vehicle operator returns and the vehicle ignition switch is turned on, or a key fob is used to unlock a door, while the ambient temperature is below the trigger temperature. Inlet door position may be determined by feedback voltage, counting actuator motor pulses or the like. The counter component 26 ensures that the timer component only operates through so many, predetermined cycles before the snow infiltration prevention system is switched off for failure to complete the opening or closing of the inlet door 16.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An apparatus for preventing snow infiltration of a vehicle HVAC system, comprising:
a fresh air inlet door for drawing fresh air into the vehicle HVAC system;
an actuator for opening and closing said fresh air inlet door; and
a controller connected to said actuator and configured to close said inlet door when an ignition switch of the motor vehicle is switched off or engine RPMs are zero.

2. The apparatus of claim 1, wherein said controller includes an ignition status component that monitors status of said ignition switch.

3. The apparatus of claim 1, wherein said controller includes an engine RPM monitor.

4. The apparatus of claim 2, wherein said controller includes an ambient temperature component that monitors ambient temperature, said controller configured to close said inlet door only when said ignition switch is switched off and the ambient temperature is below a predetermined trigger temperature.

5. The apparatus of claim 4, wherein said controller includes a vehicle door status component that monitors opening and closing of at least one door of the motor vehicle, said controller configured to close the inlet door only when said ignition switch is switched off, the ambient temperature is below the predetermined trigger temperature and said at least one vehicle door has been opened and closed.

6. The apparatus of claim 4, wherein said controller includes a vehicle door status component that monitors a door lock of a door of the motor vehicle, said controller configured to close said inlet door only when said ignition switch is switched off, the ambient temperature is below the predetermined trigger temperature and at least one vehicle door has been locked.

7. The apparatus of claim 5, wherein said controller includes a timer component and a counter component for timing and counting opening and closing of said at least one vehicle door.

8. The apparatus of claim 7, wherein said timer component and counter component are also provided for timing and counting closing of said fresh air inlet door.

9. The apparatus of claim 4, further including a vehicle occupant monitor, said controller responsive to said vehicle occupant monitor and configured to close the inlet door only when the ignition switch is switched off, the ambient temperature is below a predetermined trigger temperature, all vehicle doors are closed and said vehicle is free of any occupant.

10. A method for preventing snow infiltration of a vehicle HVAC system, comprising:
monitoring ignition status by means of an ignition status component of a controller; and
closing a fresh air inlet door of the vehicle HVAC system by means of an actuator under control of said controller when the ignition is switched off.

11. The method of claim 10, further including monitoring ambient temperature by means of an ambient temperature status component of said controller and closing said fresh air inlet door only when the ignition is switched off and the temperature is below a predetermined trigger temperature.

12. The method of claim 11, further including monitoring vehicle door status by means of a vehicle door status component of said controller and closing said fresh air inlet door only when the ignition is switched off, the temperature is below said predetermined trigger temperature and the vehicle doors have been opened to allow exit of vehicle occupants and then closed whereby air pressure is vented from said vehicle through the fresh air inlet as said vehicle doors are closed before closing said fresh air inlet door to prevent snow infiltration.

13. The method of claim 12, further including monitoring vehicle occupancy status by means of a vehicle occupant monitor and closing said fresh air inlet door only when the ignition switch is switched off, the ambient temperature is below said predetermined trigger temperature, all vehicle doors are closed and said vehicle is free of any occupant.

14. The method of claim 12, including opening the fresh air inlet door of the HVAC system by means of the actuator under control of the controller when the ignition switch is switched on and the temperature is below said trigger temperature.

15. The method of claim 12, including opening the fresh air inlet door of the HVAC system by means of the actuator under control of the controller when a key fob unlocks a vehicle door of the motor vehicle.
